(19) United States
(12) Patent Application Publication
(10) Pub. No.: US 2007/0162710 A1
(43) Pub. Date: Jul. 12, 2007

(54) Parallel processing memory cell

(76) Inventor: Victor A. Wiseman, Centralia, WA (US)

Correspondence Address: Victor A Wiseman;#508, 117 W Magnolia, Centralia, WA, 98531-4302, US

(21) Appl. No.: 11/475,266

(22) Filed: Jun. 26, 2006

Related U.S. Application Data
(60) Provisional application No. 60/757,409, filed on Jan. 9, 2006.

(51) Int. Cl. G06F 13/00

(52) U.S. Cl. 711/154

(57) ABSTRACT

A digital memory cell incorporated into an integrated circuit in a standard package containing: a two dimensional array of such memory cells each of which can hold one bit of data and each of which incorporates an arithmetic logic unit which can perform logical and arithmetic operations on data bits stored in, or generated by, selected memory cells immediately adjacent to the given cell without need of a sequential clock and; additional support logic to read/write data from/to such memory cells within the array and to program the arithmetic logic unit in each such memory cell to perform a desired function.

### CROSS-REFERENCE TO RELATED APPLICATIONS

This application claims the benefit of provisional patent application Ser. No. 60/757,409, filed Jan. 9, 2006 by the present inventor.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to memory chips manufactured for incorporation into general purpose computer systems.

2. Prior Art

Prior art most relevant to my invention is manifest in products based on programmable logic devices (PLDs), field-programmable gate arrays (FPGAs) and adaptive computing machines (ACMs).

PLDs are represented by devices such as programmable read-only memory (PROM), erasable programmable read-only memory (EPROM), programmable logic arrays (PLAs) and programmable array logic (PALs); all of these have been around since the mid 1980's. PROMs and EPROMs are limited in that they are strictly memory devices and contain no processing logic; on the other hand, PLAs and PALs can be configured to perform processing logic but cannot be used as read-write memory. Finally, none of these devices can be dynamically re-configured.

FPGAs, which came on the market in the late 1980's and are not actually “programmable”, can be dynamically reconfigured but they cannot be read or written as random access memory. Also, their structure is linear and one dimensional; there are a limited number of inputs and outputs which must be accessed externally and it is generally necessary to load the entire device which means halting the device while it is being reconfigured. Finally, the basic element in an FPGA is some form of logic gate such and an OR gate or an AND gate whose logic can't be changed; if a particular processing function requires 20 OR gates and there are only 10 available in the array that function cannot be implemented; conversely, if a particular processing function requires only 1 OR gate, then the remaining 9 are wasted.

ACMs are a recent addition to the market place, 2002 I believe. While these devices overcome the difficulties mentioned above, they are still limited to special purpose applications such as cell phones that need to do triple-duty as an iPod and a PDA; they are not suitable to general purpose computers where a capability of parallel processing would be advantageous.

### OBJECTS AND ADVANTAGES

My invention dose not suffer from the limitations mentioned above. In brief, my Parallel Processing Memory Cell is a functional 1-bit arithmetic logic unit (ALU) that can also act as random access memory storage for one bit of data whose advantages are:

(a) that it can be accessed in essentially the same manner as any conventional random access memory;

(b) that it can be programmed with a logical data address that is independent of, and unrelated to, its physical address (multiple physical addresses can have the same logical address);

(c) that it can be dynamically reprogrammed both spatially and temporally by which I mean that it can be reprogrammed at any time without interfering with the operation of any other identical cell on the same chip;

(d) that no element (cell) need go unused as in the FPGAs described above;

(e) that, in conjunction with a multitude of identical cells on the same chip, it can perform parallel processing; for example, in the preferred embodiment described below, the chip can be programmed to perform 650 32-bit additions concurrently and in parallel since it does not rely on a system clock;

(f) that, once the chip is programmed for a certain function, there is no set logical limit to the amount of data that can be written into or read from the chip as in an FPGA and, in fact, if a given operand for the function is required in more than one place, such as a multiply function, that operand will be written into all locations where it is required with a single write command;

(g) that operands can be of any length of 1 bit or greater;

(h) that the chip can be manufactured inexpensively with current and well established and understood technology; in the preferred embodiment described below the resultant chip should sell for under $10.

### SUMMARY

In accordance with the present invention a parallel processing memory cell capable of having unrelated physical and logical data addresses and be capable of being programmed to carry out arithmetic and logical functions on data that has been written into it and identical cells immediately adjacent to it.

### DRAWINGS—FIGURES

FIG. 1 is a block diagram showing the logical structure of the cell in the preferred embodiment and how individual elements within the structure are physically interconnected.

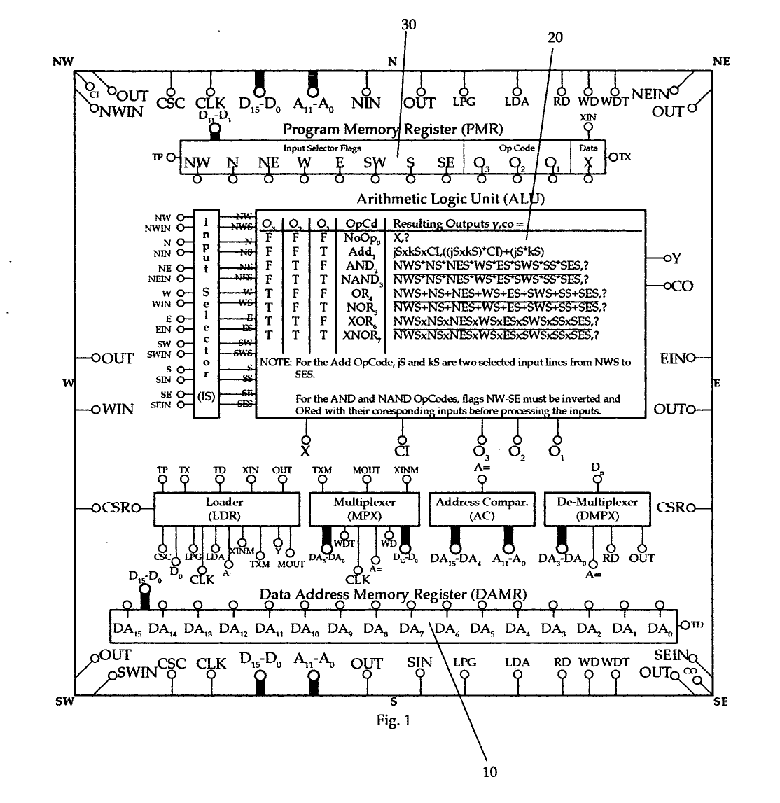

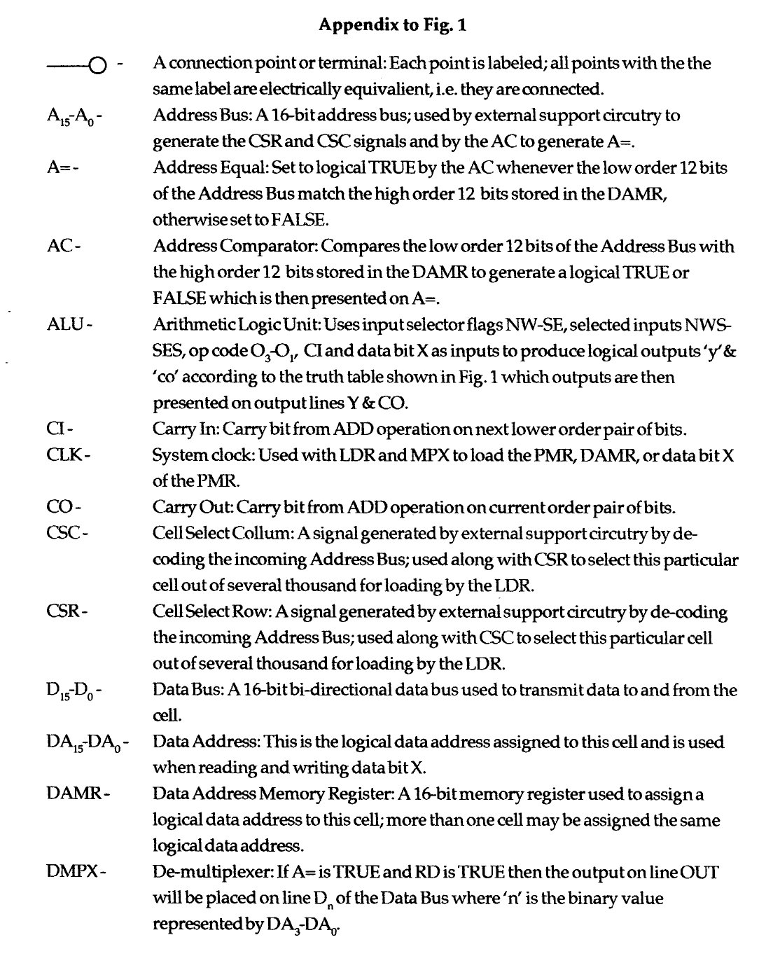

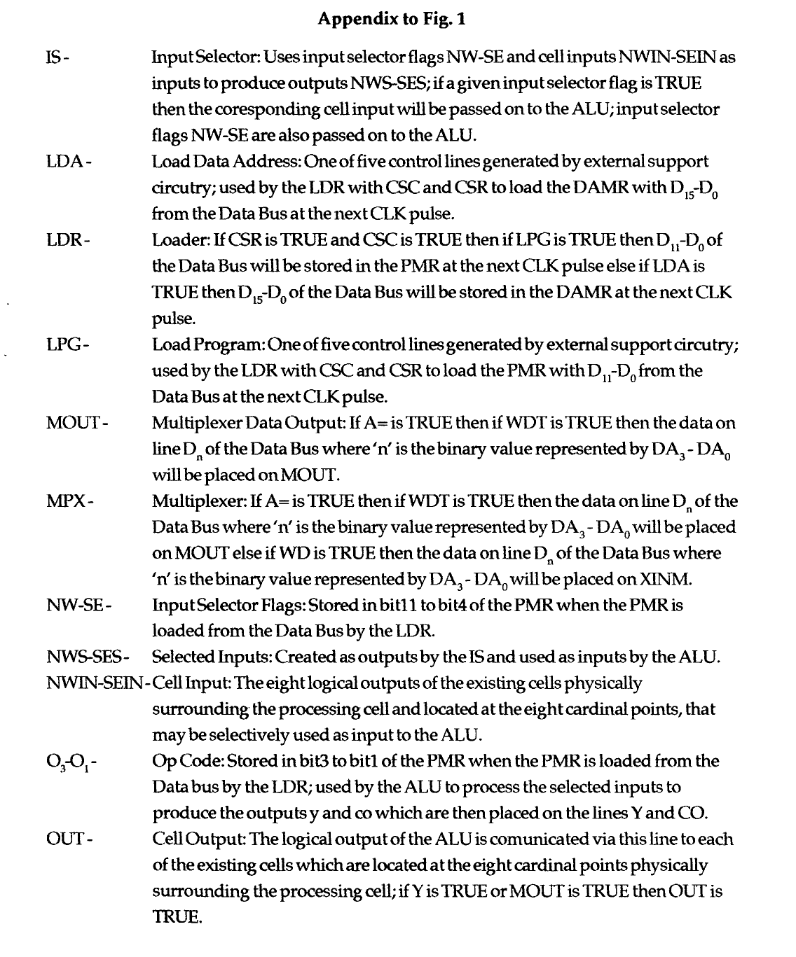

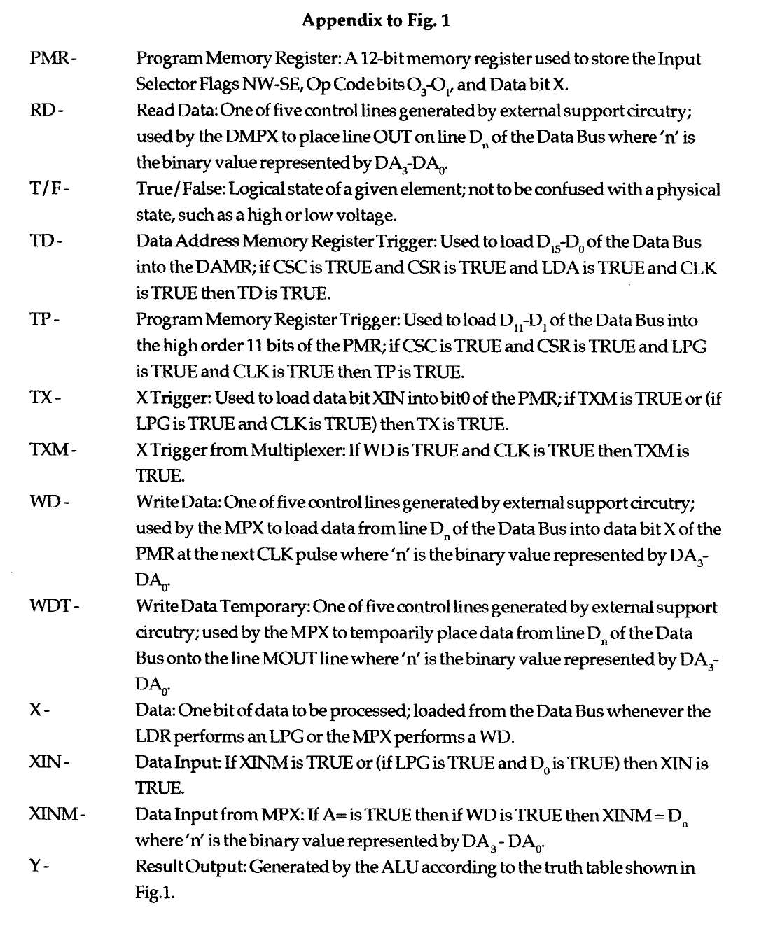

Appendix to FIG. 1 defines and describes, in detail, each element and symbol within the structure and how it logically functions and/or relates to other elements and symbols within the structure.

### DRAWINGS—REFERENCE NUMERALS

With reference to FIG. 1, all elements but three are standard digital logic circuits that provide functional support to the remaining three. The remaining three, identified with call-out numbers, form the basis of my claim as stated on page 5; they are:

10—Data Address Memory Register—constitutes First Means

20—Arithmetic Logic Unit—contitutes Second Means

30—Program Memory Register—contitutes Third Means

### DETAILED DESCRIPTION—PREFERRED EMBODIMENT—FIG. 1

The preferred embodiment would be in a standard 40-pin DIP package using a 16-bit data bus, a 16-bit address bus, a 3-bit control bus, chip select, clock, V_{CC}, Gnd, and one pin unused. The chip would contain a two dimensional array of 65,536 memory cells, each as described in FIG. 1 and Appendix to FIG. 1, arranged in 256 columns and 256 rows. Each cell would be physically connected to each of the eight cells immediately adjacent to it in such a fashion so as to allow data to be transfered to and received from each of those eight cells. The chip would also contain support logic to de-code information provided on the address bus and control bus to facilitate data read/write operations and the programming of each cell.

### OPERATION—PREFERRED EMBODIMENT—APPENDIX TO FIG. 1

The 16-bit data bus is used to read/write data from/to memory cells selected by the 16-bit address bus and to program memory cells selected by the 16-bit address bus. The 3-bit control bus is used to determine which of five operations will be performed by the chip; load program, load data address, read data, write data, write data temporary. Chip select is used to select a given 40-pin chip out of a multitude of identical chips mounted on the same printed circuit board. Clock is used to load data and program into the memory cells from the data bus. V_{CC} and Gnd provide power to the chip.

### DESCRIPTION—ALTERNATE EMBODIMENTS

The preferred embodiment can be scaled up/down with a larger/smaller address bus and/or a larger/smaller data bus for special purpose applications. Also, a two dimensional array smaller than 65,536 cells may be used for special purpose devices; for example, a chip to perform encryption/decryption on 32-byte strings of data would need less than a thousand cells. Finally, the ALU can be scaled up/down to recognize more/fewer operation codes.

### OPERATION—ALTERNATE EMBODIMENTS

The operation of alternate embodiments would be identical to the preferred embodiment with appropriate modifications to utilize a different size data bus and/or address bus and/or ALU.

### CONCLUSION, RAMIFICATIONS, AND SCOPE

Accordingly, the reader will see that this Parallel Processing Memory Cell operating as a 1-bit ALU, when used in conjunction with thousands of identical cells, can perform any function a general purpose ALU can perform. Once a matrix of cells is programed for a specific function, the user need only write the operands into the memory cells and then can, in effect, immediately read out the result of the function.

Also, since each cell operates at the bit level, there is no restriction on the size of the operands used as inputs to a function; it is just as easy, for example, to add two 70-bit numbers as it is to add two 5-bit numbers. Conversely, if your numbers are only five bits long, you don't have to do a 32-bit add to get your result as you would have to do with a 32-bit MPU.

1. A digital computer memory cell comprising:
(a) first means for storing within said cell a logical data address independent of and unrelated to said cell's physical address whereby a plurality of identical cells with different physical addresses can respond to a given read or write operation;
(b) second means for performing arithmetic and logical operations on zero or more data inputs provided by a plurality of identical cells including said cell;
(c) third means for storing within said cell an appropriately coded instruction to control and direct said second means for performing arithmetic and logical operations whereby the resulting output thus generated by said second means will constitute useful input to a plurality of identical cells not including said cell.

2. A digital memory chip, comprising:
(a) an M×N array of memory cells according to claim 1 each of which are connected to each of the eight cells immediately adjacent to it in such a fashion so as to allow data to be transfered to and received from each of those eight cells;
(b) additional digital logic support to facilitate the transfere of data to and from said memory chip.
